(19) United States
(12) Patent Application Publication
(10) Pub. No.: US 2007/0011200 A1
(43) Pub. Date: Jan. 11, 2007

(54) OPERATING AUXILIARY APPARATUS

(75) Inventor: Dong Cheon Park, Osan-si, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/427,819

(22) Filed: Jun. 30, 2006

(30) Foreign Application Priority Data
Jul. 6, 2005 (KR) 10-2005-0060632

(51) Int. Cl. G06F 17/00

(52) U.S. Cl. 707/104.1

(57) ABSTRACT

Operating an auxiliary apparatus, such as a media player enabled by a CPU, includes concurrently initializing a main system and the media player in response to a user command. Data of the media player is loaded and output from the media player while the media player is initialized. When a main system is off or in a stand-by mode, a user can input a user command through a user interface provided on an auxiliary apparatus. The main system and the auxiliary apparatus are concurrently initialized, hardware and software is loaded, and data of the auxiliary apparatus is outputted in response to the input of the user command.

### BACKGROUND

This description relates to the operation of an auxiliary apparatus connected to a computer system.

In general, media for operation with a computer system refers to a disk used as a storage media in a storage apparatus and/or an auxiliary apparatus or other hardware. Instant media play capability is typically based on a Windows operating system (OS) or Linux OS. For example, the Windows OS includes a direct media experience type and an embedded media experience type. In the direct media experience type, when a specific button is pressed, a computer is resumed from a hibernation or sleep mode by applying a quick fix engineering (QFE) patch or fix necessary for the delivery of individual service updates to the computer's operating system and/or application programs. For example, the direct media experience type may be delivered in an existing Windows XP environment. A target media application is then executed and/or delivered in the Window OS of the computer.

A hibernation mode enables contents running in a random access memory (RAM) to be saved to a disk as an image file, and then when resuming full operation, the image file is read from the disk and saved to the RAM again without having to undergo various booting processes. Accordingly, a temporary pause or sleep state can be achieved by performing the hibernation mode. Since complete OS booting processes are executed from the complete power-off state in the direct media experience type, the instant media player requires significant time to operate.

A Linux based instant media player typically includes hardware drivers that are not supported in the Linux OS and also in the Windows OS. However, since optimization for the target platform can be easily achieved, and a fast operation environment can be provided particularly in the Linux OS, the Linux based instant media play has been widely used as an instant media playback system. However, the Linux based playback feature was developed based on a specific hardware platform and is not normally operated in another platform, such as a platform supporting Windows OS. The Linux playback feature typically includes a user interface having media controls such as Play, Stop, Pause, F.Fwd, and/or F.Rwd for an instant media player.

### SUMMARY

In one general aspect, a method of operating a media player enabled by a CPU includes concurrently initializing the CPU and the media player in response to a user command. Data of the media player is loaded and output from the media player.

Implementations may include one or more of the following features. For example, a system of the CPU may be initialized when a predetermined button is selected by a user, and the media player is initialized in parallel with the CPU with a boot loader program stored in a memory device of the CPU.

Media data of the media player may be stored in a memory device.

Data may be stored in a memory device and is prioritized, such as a user designating a playback order of multiple data types.

Prioritizing data can include designating media data into a dominant data set and into at least one subordinate data set, wherein the dominant data set is arranged to be output before the at least one subordinate data set is output.

The concurrent initialization of the CPU and the media player may be in response to a user command and occurs when the CPU is initially in a sleep mode.

In another general aspect, a method of operating an auxiliary apparatus operatively connected to a computer system and having an instant media player includes loading an operating system (OS) kernel to initialize the computer system and the instant media player simultaneously. An apparatus driver on the OS kernel is registered and a service environment necessary for the instant media player is loaded. The method includes searching available data in the auxiliary apparatus to operate a corresponding instant media player, loading the data, and then storing the data in a buffer while registering the apparatus driver. The method includes outputting the data stored in the buffer after initializing the computer system and the instant media player.

Implementations may include one or more of the following features. For example, the instant media player may output files stored in an optical disk drive (ODD) or a hard disk drive (HDD) of the second apparatus.

Searching available data may include installing the apparatus driver for the instant media player, and detecting if data is available for the instant media player after installing the apparatus driver.

The method may include storing the detected data in an additional buffer after loading the corresponding data.

Outputting the data may include loading a user interface for the instant media player, and outputting the data stored in the buffer through the loaded user interface.

The method may include loading a user interface for the instant media player, and designating the instant media player in a stand-by state if data for the instant media play is not detected.

In another general aspect, a method of operating an auxiliary apparatus having an instant media player, the method including receiving information in response to a user input, entering an instant media play mode when predetermined information is received, and concurrently initializing the auxiliary apparatus and a second apparatus in parallel. The method includes operating hardware and software to operate the second apparatus, and outputting data stored in the second apparatus.

In another general aspect, a method of operating a system having at least one auxiliary media apparatus includes receiving a user input from a second media apparatus. A first apparatus is initialized and a program for operating the second apparatus and the first apparatus concurrently is executed. The method includes registering an operating system of the first apparatus and a driver of the second apparatus in a kernel, operating a driving unit of the second apparatus and storing data of the recognized second apparatus in a memory device, and outputting the stored data from the memory device.

Implementations may include one or more of the following features. For example, the method may include selecting a data set to be output from a plurality of data sets stored in the memory device.

The method may include outputting the selected data set only if the selected data set is supported by the second apparatus. The second apparatus is designated in a standby status when data selected by a user is not supported by the second apparatus.

The method may include selectively designating data to be output by the second apparatus.

In another general aspect, a system for operating a peripheral media device includes the peripheral media device, a first controller for controlling the system, a second controller connected to the first controller to control the peripheral media device, a memory unit for storing a system operating program and a program controlling the peripheral media device to operate with the system, a BIOS ROM for storing a program controlling fundamental operations of the system and the peripheral media device, and an input unit configured to control an instant media playback feature of the peripheral media device.

Implementations may include one or more of the following features. For example, the peripheral media device may include at least one of an optical disk drive, a hard disk drive, or a multimedia player.

The peripheral media device may be configured for outputting one or more of audio data or video data.

Other features will be apparent from the following description, including the drawings, and the claims.

### BRIEF DESCRIPTION

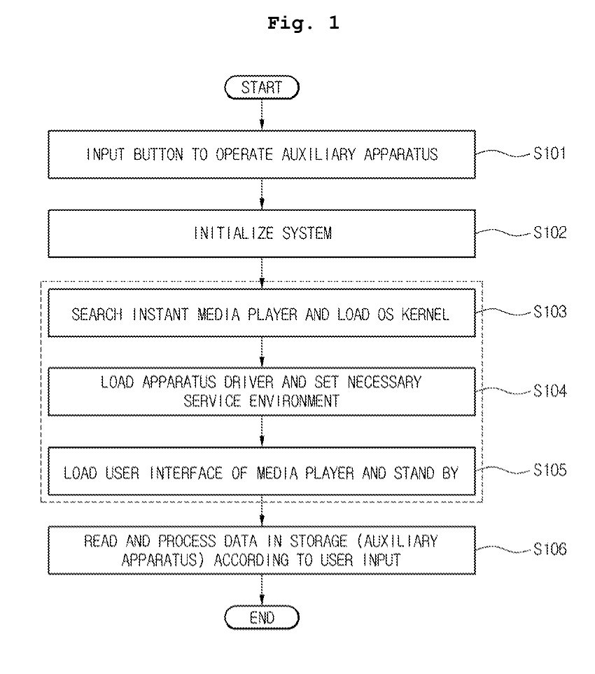

FIG. 1 is a flowchart of a process for initializing an auxiliary apparatus.

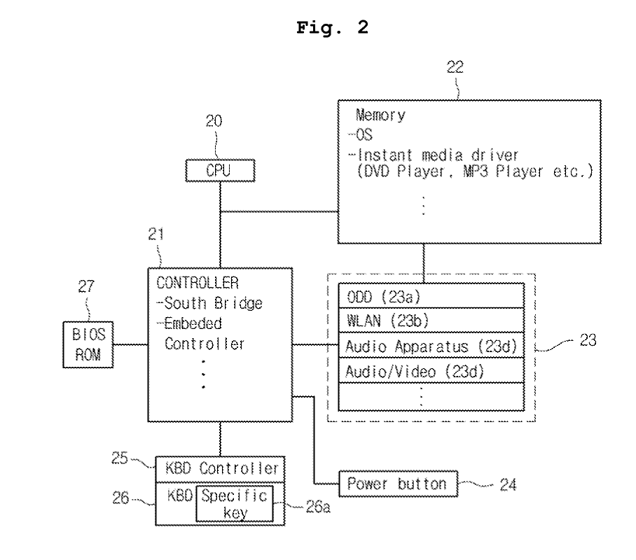

FIG. 2 is a block diagram of an exemplary auxiliary apparatus connected to a computer system.

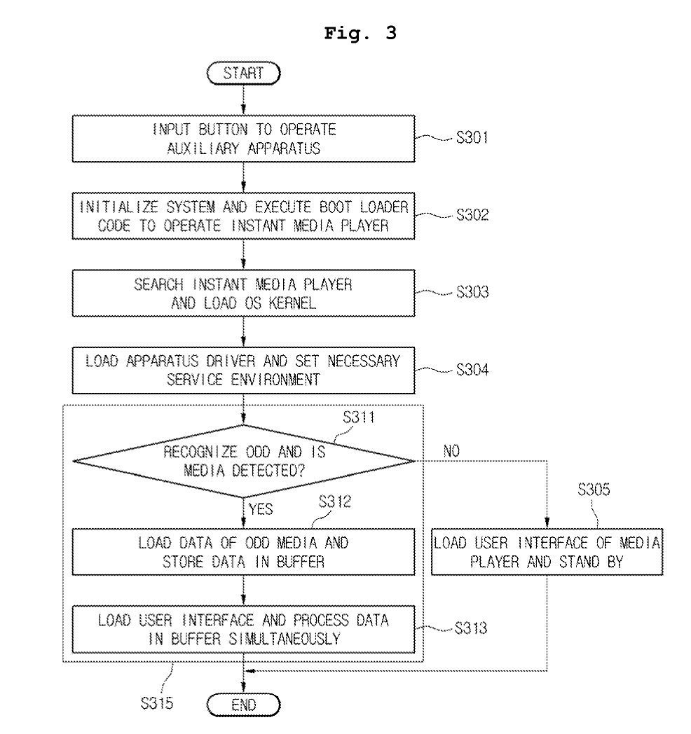

FIG. 3 is a flowchart of a process for operating an auxiliary apparatus.

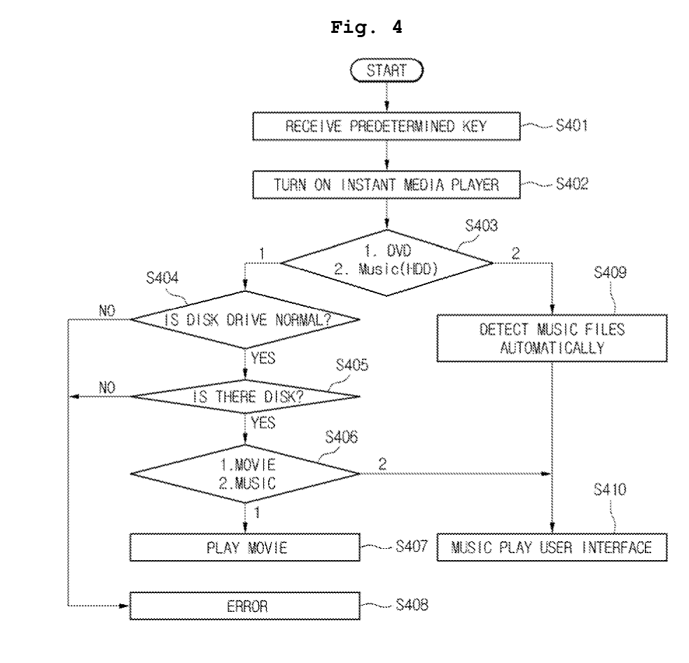

FIG. 4 is a flowchart of an operating sequence of an instant media player.

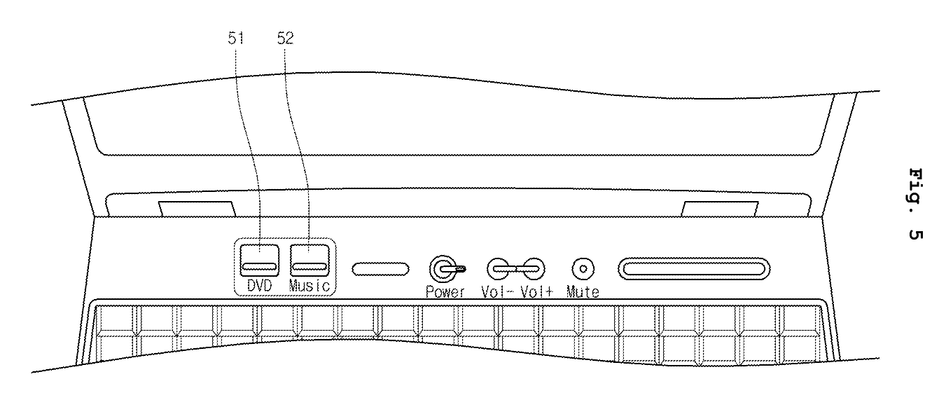

FIG. 5 is a schematic view of an input interface unit for operating an auxiliary apparatus.

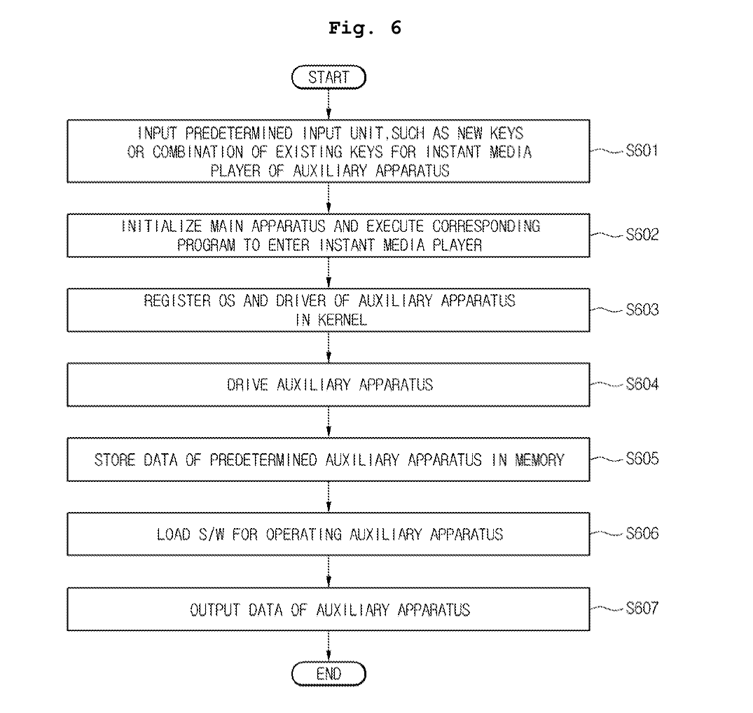

FIG. 6 is a flowchart of a process for operating an auxiliary apparatus.

### DETAILED DESCRIPTION

An instant media player may include a combination of a multimedia embedded system and an application program. An environment for a multimedia player is independent from an operating system (OS) of a personal computer (PC) based system. An OS kernel is typically optimized for the corresponding system, an apparatus driver or drivers, various codecs, and a media player program configured to perform the operations, such as instant media playback. In addition, an additional button allocation for controlling the instant media player, a circuit configuration, and a specified basic input/output system (BIOS), power-on self test (POST) routine may be embodied in the OS kernel.

Referring to FIG. 1, an exemplary instant media playback uses the operation of an auxiliary apparatus mounted or connected to a system, such as an optical disk drive (ODD). The ODD is connected to a personal computer (PC) system and can be operated by an external operation button without having to reboot the system. For example, a user presses a predetermined button which operates the auxiliary apparatus (S101) without having to boot the PC system. In operation S102, a boot loader code is executed to enter a power-on self test (POST) routine for initializing the system and the instant media player after a basic input/output system (BIOS) of the PC system recognizes the corresponding button.

In operation S103, the executed boot loader searches an instant media player and loads an OS kernel. Moreover, in operation S104, the boot loader registers an apparatus driver as a kernel module and sets a service and an environment to operate the instant playback application. Once fundamental operations for the instant playback application are completed, a user interface of the media player is loaded and then in a standby mode for a play input from the user (S105). In operation S106, media data of the auxiliary apparatus is read and processed depending on the input from the user.

As described the above, when the BIOS is optimized to execute the minimized initialization process for the instant media player in operations S101 and S102, it may take approximately 5 seconds or longer to initialize the main system during operating processes of a typical instant media player. Additional time can be required to launch an environment of the instant media player during operations S103 to S105. The required time can be reduced to approximately 5 seconds through an optimization of the OS kernel and middleware.

The booting process is completed through the operations S101 to S105. The booting of the instant media player is completed and is ready within approximately 10 seconds of the start of the first of all of the combined processes. An additional 4 to 10 seconds or more can be required to display an image and/or audio after processing graphic and audio data through a storage play apparatus, such as an auxiliary hard disk drive (HDD) or ODD.

When the main computer system is turned off, a typical instant media player outputs the media of the auxiliary apparatus after booting or rebooting of the main system. Accordingly, a user may have to wait as long as 20 seconds or more from the point that a computer system has been activated from a hibernation mode to operate an instant media player, e.g., an additionally 4 to 10 seconds after even operations S101 to S105 are complete.

Since the typical instant media player application is initiated after system booting has occurred, the user's operating experience involves relatively long system and auxiliary initialization times. Further, additional time may be required to detect media available in the auxiliary apparatus and/or to play the media once the system and auxiliary apparatus are initialized.

Accordingly, the actual preparation or initialization time for the instant media player can be reduced by including an auxiliary apparatus operation, a media recognizing operation, and/or data loading operation at the same time or substantially concurrent with fundamental functions of the main system, e.g., such as typical system initialization in response to activation from a “sleep” mode.

Referring to FIG. 2, an exemplary system includes a CPU 20 for controlling an overall system, a controller 21 connected to the CPU to perform at least a adjusting function of a system memory bus input/output or an input/output function of an auxiliary apparatus 23, and a memory unit 22 for storing an OS or a program controlling the auxiliary apparatus 23. The peripheral or auxiliary apparatus 23 is controlled by the controller 21 and may include auxiliary devices, such as an optical disk drive (ODD) 23a, a compact disk (CD) 23b, an audio device 23c, and an audio/video device 23d, a BIOS read only memory (ROM) 27 for storing a program controlling fundamental operations of the system, a keyboard 26 as an input unit having a specific key 26a for the instant media player of the auxiliary apparatus, a keyboard controller 25 for controlling the keyboard, and a power button 24. An activation key for the instant media player can be included in the auxiliary apparatus and/or the system. For example, the instant media player can be operated by pressing a combination of existing keys on the keyboard, the auxiliary apparatus and/or the CPU 20.

Referring to FIG. 3, an exemplary operating process permits operation of the instant media player without having to reboot the main system, e.g., while in a sleep mode. The ODD of the auxiliary apparatus connected to the CPU 20 of the main system includes the instant media player feature. The instant media player can be operated without booting the system when a user selects a predetermined button.

In operation S301, a user selects a predetermined button to operate the auxiliary apparatus. In operation S302, the system BIOS executes a boot loader code to enter the POST routine for simultaneously initializing the main system, and the instant media player of the auxiliary apparatus S302. In operation S303, the executed boot loader searches the instant media player and loads the OS kernel. In operation S304, the boot loader registers the apparatus driver as a kernel module, and sets a service environment for an operation of the instant playback application.

In operation S311, the ODD driver is registered and recognized, and the system automatically determines if media is present. The system simultaneously determines if other apparatus drivers are registered in the kernel module, and if the ODD has media by automatically recognizing the ODD. If ODD media is detected, the media data is loaded and stored in a buffer in operation S312.

Once the loading of the necessary service and the setting of the environment are completed, the media can be played by processing the data stored in the buffer and loading a user interface simultaneously in operation S313. If the media is not automatically recognized, the user interface is loaded and the media player will operate in a stand by until the user inserts the media or inputs an operation for the player in operation S305.

The operations S311 to S313 are suboperations of operation S315 which are performed simultaneously in response to operation S304, or even concurrently with operation S304. For example, when a predetermined specific key is selected by a user, the main system is booted, and the hardware for the operating the auxiliary apparatus and related software are executed concurrently.

Accordingly, when the operating driver of the ODD is installed on the kernel module, the media is recognized simultaneously. After the data is loaded in the system buffer, the data is processed as soon as the boot process is complete. However, in contrast to an apparatus which is initialized after the system boots, the elapsed time from when the auxiliary apparatus is operated until the media is processed after system booting can be reduced by simultaneously initializing the auxiliary apparatus 23 and the system.

An exemplary process for activating the instant media player by pressing a predetermined key includes one or more of the following features. An additional primary partition is prepared separate from a partition storing a main OS within the memory 22, and all application software for the instant media player is stored on the primary partition. A file system ID of the primary partition is set to be unique, e.g., 0x88, so as to be easily distinguished from a Windows NT file system (NTFS) and/or a file allocation table 32 (FAT32). A unit ID, such as a wake source identifier, is recognized as a specific key for the instant-on play feature, and the instant media player mode is entered by executing a first boot sector of the primary partition for the instant media player among available partitions in memory 22.

The booting process of the auxiliary apparatus can include the following. A controller for the auxiliary apparatus is initialized during the initialization of the system. A driver for the auxiliary apparatus is loaded during the registering of an apparatus driver in the OS kernel. An environment for communicating with the auxiliary apparatus, e.g., ODD, is established when the driver is loaded and the system initiates data retrieval from the auxiliary apparatus 23 and stand by of the apparatus 23 until a user provides a command. A spindle is driven by firmware in the auxiliary apparatus, e.g. ODD, and then a process for loading required data is performed.

Referring to FIG. 4, a system may include more than one auxiliary apparatus, e.g., an ODD and an HDD. In contrast to operation S315, media processes of the HDD auxiliary apparatus and/or the ODD auxiliary apparatus are performed. In S401, information indicating a selection of a predetermined key is received, and the hardware and software are operated to turn on the instant media player of the auxiliary apparatus S402.

In operation S403, the auxiliary apparatus is searched for the instant media player and it is determined whether the ODD, e.g., having a digital video disk (DVD)), or the HDD, e.g., having MP3 files, is in operation. In general, the user selects the auxiliary apparatus to be operated and/or the appropriate data to be output from the auxiliary apparatus, e.g., assuming the data is supported by the auxiliary apparatus.

If the user does not select the apparatus or the data, the data of the ODD is generally output first. Moreover, audio data is prioritized as being output first when both audio data and video data are present. A DVD player is merely an example of one type of ODD apparatus, and the media files stored in the HDD are not limited to music files, but may be various types of media files.

If a DVD player is set to operate before the HDD (music files), a driver of the DVD is registered and it is determined if a normal operation can be performed in operation S404. In operation S405, the DVD player is also monitored to determine the presence of available media, e.g., is a DVD present, in the DVD apparatus. If the DVD apparatus is not normal or the media is not inserted, an execution error occurs in operation S408. Referring to FIG. 3, the operation S305 is executed if the execution error occurs and the apparatus enters a standby state.

If media (disk) is inserted in the DVD apparatus, the type(s) of media files, e.g., movie files or music files, stored in the apparatus are determined in operation S406. If movie files are stored in the media, the movie files are played in operation S407. If music files are stored in the media, the user interface for playing music is provided in operation S410. Alternatively, the music to be played may be designated by the user as soon as the user interface is provided in operation S410. The music files of the HDD that are played on the instant media player in operation S403 are automatically recognized in operation S409.

Referring to FIG. 5, an exemplary notebook computer includes an Instant-On play feature. The notebook computer additionally includes an input interface with buttons, e.g. a DVD button 51 and a Music button 52, for initiating Instant-On play features. Moreover, it is possible to control the media player features using a remote controller and/or any combination of preset keys on the keyboard (shown below the buttons 51, 52).

When power to the notebook computer is turned off, the instant media player functions can be initiated by manipulating the DVD button or Music button for a long enough period, e.g., one or two seconds. The corresponding media files are then played after the media is recognized within the auxiliary apparatus.

When performing the Instant-On play feature, the boot speed can be improved because the boot loader initializes a minimum hardware resource. A middleware using a fully optimized Linux kernel can also be configured to control unnecessary services and functions.

A desirable instant media player function can be achieved by adding an additional file system and/or configuring an additional primary partition in the auxiliary apparatus to store the music files.

Referring to FIG. 6, when the system is not operated, a value of a predetermined input unit is inputted, e.g. an additional button or combined keys, to operate the auxiliary apparatus in operation S601. Accordingly, the boot loader code is executed to operate the auxiliary apparatus simultaneously with the initialization of the main apparatus in operation of S602.

In operation S603, the main apparatus OS and the driver of the auxiliary apparatus 23 are registered in the OS kernel. The spindle of the auxiliary apparatus is operated in operation S604, and the media data of the recognized auxiliary apparatus is stored in the memory in operation S605. Additionally, the service environment for driving the media playback application is set in operation S606, and the media of the auxiliary apparatus is outputted through the loading of the media player user interface in operation S607.

It should be understood that the above-described implementations are not limited by any of the details of the foregoing description. Accordingly, other implementations are within the scope of the following claims.

For example, a determination of which of a normal PC operation and an instant media player operation is launched may be based on a stored wake source identifier. For example, when a DVD button and a Music button are provided (see FIG. 5), an instant DVD play mode is operated when the DVD button is pressed and an instant music play mode is operated when the music button is pressed.

Alternatively, even if a user selects the music button, if there is a DVD title in the ODD, the instant DVD play mode is performed because the ODD or DVD media has been designated as being played first based on the settings of the auxiliary apparatus. However, the play order or media priority can be customized by the user or during manufacture of the computer and the auxiliary apparatus.

The foregoing apparatus and method reduce the time a user must wait to use an auxiliary apparatus after the main system initialization has begun. The input unit detects the input of a predetermined input from a user without having to boot the system, and the main system and the auxiliary apparatus are initialized simultaneously, resulting in faster loading of hardware and software. When booting the main system, the auxiliary apparatus is booted simultaneously and a wait time is reduced because the auxiliary apparatus is operated concurrently with the main system booting, and is therefore available for use simultaneously or shortly thereafter the main system is booted.

The instant media play feature in the computer system can be executed within a minimized time, e.g., less than the 4 to 10 seconds typically required after a main system boots. For example, a BIOS POST routine can be incorporated that detects and stores a wake source identifier that requests an Instant-On play function when there are a plurality of buttons for the instant media player. For example, a BIOS POST routine can permit the detection of an audio-visual key from a keyboard controller or remote controller and can include the following exemplary source code.

It should be understood that the above-described implementations are not meant to be limiting. limited by any of the details of the foregoing description. Accordingly, other implementations are within the scope of the following claims

SAMPLE BIOS POST ROUTINE

| GET_REMOTE_KEY | | PROC NEAR | |
|---|---|---|---|
| | IN | AL, 21H | |
| | OR | AL, 02H | ; MASK IRQ1 |
| | OUT | 21h, AL | |

;/////DETECTING
KBC///////////////////////////////////////////////////

| | | |
|---|---|---|
| MOV | CX, 1000 | ; PRESET LOOP COUNTER |

KEYB_SELFTEST_CTLR_Label0:

| | | |
|---|---|---|
| IN | AL, 064H | ; KBSTAT |

| | | | |
|---|---|---|---|
| TEST | AL, 001H | ; KBOBF | ; OUTPUT BUFFER FULL? |

| | | |
|---|---|---|
| JZ | TEST_IBF0 | ; NO, GO TRY THE INPUT |

BUFFER

| | | |
|---|---|---|
| IN | AL, 60H | ; FLUSH PENDING DATA |

TEST_IBF0:

| | | |
|---|---|---|
| IN | AL, 064H | ; KBSTAT |

| | | | |
|---|---|---|---|
| TEST | AL, 002H | ; KBIBF | ; INPUT BUFFER FULL? |

| | | |
|---|---|---|
| JZ | SEND_AA0 | ; NO, GO INIT THE 8042 |

| LOOP KEYB_SELFTEST_CTLR_Label0; LOOP... | |
|---|---|
| JMP | No_KBC |

SEND_AA0:

| | | |
|---|---|---|
| MOV | AL, 0AAH | ; KBSELFT; KBC SELF-TEST |

COMMAND

| | |
|---|---|
| OUT | 64h, AL |

| | |
|---|---|
| MOV | CX, 0F000H |

@@:

| | | | |
|---|---|---|---|
| IN | AL, 064H | ; KBSTAT | ; READ KBC |

STATUS PORT

| | | | |
|---|---|---|---|
| TEST | AL, 001h | ; KBOBF | ; CHECK OUTPUT |

BUFFER BIT

| | |
|---|---|
| JNZ | obf_set0 |
| LOOP | @B |

obf_set0:

| | TEST | AL, 01H | ; DID WE GET A RESPONSE? | |
|---|---|---|---|---|
| | JZ | No_KBC | | |
| Get_Reply0: | | | ; WE GOT A REPLY FROM THE | |
| KEYBOARD | | | | |
| | IN | AL, 60H | | |
| | CMP | AL, 055h | ; SELFTEST PASS | ; WAS THE |

REPLY A PASS?

| | |
|---|---|
| JNE | No_KBC |

////READING KBC
STATUS///////////////////////////////////////////////
;0EFh: COMMAND OF READING THE AV KEY

| CALL | WAIT_INPUT_EMPTY | |
|---|---|---|
| MOV | AL,0EFH | ; SET READ KBC STATUS |

COMMAND

| OUT | 60h, AL | |
|---|---|---|
| CALL DELAY_1MSEC | | |
| IN | AL, 060h | ; READ KBC STATUS |

| | |
|---|---|
| ; FM Radio | 001H |

| | |
|---|---|
| ; PC | 002H |

| | |
|---|---|
| ; DVD / VCD | 004H |

| | |
|---|---|
| ; TV / VCR | 008H |
| ; CD / MP3 | 010H |

No_KBC:
;////SAVING AV
KEY////////////////////////////////////////////////////

| PUSH ES | |
|---|---|
| PUSH AX | |
| MOV | AX, 040H |
| MOV | ES, AX |
| POP | AX |

| | |
|---|---|
| MOV | BYTE PTR ES:[0D4H], AL |

| POP | ES | |
|---|---|---|
| IN | AL, 21h | |
| AND | AL, (NOT 02h) | ; UNMASK IRQ1 |
| OUT | 21h, AL | |
| RET | | |

| | |
|---|---|
| GET_REMOTE_KEY | ENDP. |

What is claimed is:

1. A method of operating a media player enabled by a CPU, the method comprising:
concurrently initializing the CPU and the media player in response to a user command;
loading data of the media player; and
outputting the data from the media player.

2. The method according to claim 1, wherein a system of the CPU is initialized when a predetermined button is selected by a user, and the media player is initialized in parallel with the CPU with a boot loader program stored in a memory device of the CPU.

3. The method according to claim 1, further comprising storing media data of the media player in a memory device.

4. The method according to claim 1, further comprising:
storing data in a memory device; and
prioritizing data stored in the memory device.

5. The method according to claim 4, wherein prioritizing data comprises designating media data into a dominant data set and into at least one subordinate data set, wherein the dominant data set is arranged to be output before the at least one subordinate data set is output.

6. The method according to claim 1, wherein concurrently initializing the CPU and the media player in response to a user command occurs when the CPU is in a sleep mode.

7. A method of operating an auxiliary apparatus operatively connected to a computer system and having an instant media player, the method comprising:
loading an operating system (OS) kernel to initialize the computer system and the instant media player simultaneously;
registering an apparatus driver on the OS kernel and loading a service environment necessary for the instant media player;
searching available data in the auxiliary apparatus to operate a corresponding instant media player, loading the data, and then storing the data in a buffer while registering the apparatus driver; and
outputting the data stored in the buffer after initializing the computer system and the instant media player.

8. The method according to claim 7, wherein the instant media player outputs files stored in an optical disk drive (ODD) or a hard disk drive (HDD) of the second apparatus.

9. The method according to claim 7, wherein searching available data comprises:
installing the apparatus driver for the instant media player; and
detecting if data is available for the instant media player after installing the apparatus driver.

10. The method according to claim 9, further comprising storing the detected data in an additional buffer after loading the corresponding data.

11. The method according to claim 7, outputting of the data comprises:
loading a user interface for the instant media player; and
outputting the data stored in the buffer through the loaded user interface.

12. The method according to claim 7, further comprising:
loading a user interface for the instant media player; and
designating the instant media player in a stand-by state if data for the instant media play is not detected.

13. A method of operating an auxiliary apparatus having an instant media player, the method comprising:
receiving information in response to a user input;
entering an instant media play mode when predetermined information is received;
concurrently initializing the auxiliary apparatus and a second apparatus in parallel;
operating hardware and software to operate the second apparatus; and
outputting data stored in the second apparatus.

14. A method of operating a system having at least one auxiliary media apparatus, the method comprising:
receiving a user input from a second media apparatus;
initializing a first apparatus and executing a program to operate the second apparatus and the first apparatus concurrently;
registering an operating system of the first apparatus and a driver of the second apparatus in a kernel;
operating a driving unit of the second apparatus and storing data of the recognized second apparatus in a memory device; and
outputting the stored data from the memory device.

15. The method according to claim 14, further comprising selecting a data set to be output from a plurality of data sets stored in the memory device.

16. The method according to claim 15, further comprising outputting the selected data set only if the selected data set is supported by the second apparatus.

17. The method according to claim 16, further comprising designating the second apparatus in a standby status when data selected by a user is not supported by the second apparatus.

18. The method according to claim 14, further comprising selectively designating data to be output by the second apparatus.

19. A system for operating a peripheral media device comprising:
the peripheral media device;
a first controller for controlling the system;
a second controller connected to the first controller to control the peripheral media device;
a memory unit for storing a system operating program and a program controlling the peripheral media device to operate with the system;
a BIOS ROM for storing a program controlling fundamental operations of the system and the peripheral media device; and
an input unit configured to control an instant media playback feature of the peripheral media device.

20. The system of claim 19, wherein the peripheral media device comprises at least one of an optical disk drive, a hard disk drive, or a multimedia player.

21. The system of claim 19, wherein the peripheral media device is configured for outputting one or more of audio data or video data.
